(19) United States
(12) Patent Application Publication
(10) Pub. No.: US 2020/0192234 A1
(43) Pub. Date: Jun. 18, 2020

(54) ELECTROSTATIC INK(S)

(71) Applicant: HP Indigo B.V., Amstelveen (NL)

(72) Inventors: Ariel HAGEGE, Nes Ziona (IL); Yaron GRINWALD, Nes Ziona (IL); Gregory KATZ, Nes Ziona (IL); Regina GUSLITZER, Nes Ziona (IL); Ziv GiLAN, Nes Ziona (IL); Yavin ATZMON, Nes Ziona (IL); Lior KATZ, Nes Ziona (IL)

(73) Assignee: HP Indigo B.V., Amstelveen (NL)

(21) Appl. No.: 16/474,703

(22) PCT Filed: Mar. 28, 2017
(86) PCT No.: PCT/EP2017/057285

§ 371 Date: Jun. 28, 2019

(51) Int. Cl. G03G 9/12; G03G 9/125; G03G 9/13; G03G 15/08

(52) U.S. Cl. CPC G03G 9/122; G03G 15/0865; G03G 9/131; G03G 9/125

(57) ABSTRACT

An electrostatic ink composition is disclosed. The electrostatic ink composition can comprise: a liquid carrier; and particles dispersed in the liquid carrier, wherein the particles comprise a thermoplastic resin, and a metal or metal alloy pigment having a melting of point of less than about 200° C. The metal or metal alloy pigment can have a diameter of from about 0.01 μm to about 50 μm.

### BACKGROUND

Electrostatic printing processes, sometimes termed electrophotographic printing processes, can involve creating an image on a photoconductive surface, applying an ink having charged particles to the photoconductive surface, such that they selectively bind to the image, and then transferring the charged particles in the form of the image to a print substrate.

The photoconductive surface is on a cylinder and is often termed a photo imaging plate (PIP). The photoconductive surface is selectively charged with a latent electrostatic image having image and background areas with different potentials. For example, an electrostatic ink composition including charged toner particles in a carrier liquid can be brought into contact with the selectively charged photoconductive surface. The charged toner particles adhere to the image areas of the latent image while the background areas remain clean. The image is then transferred to a print substrate (e.g., paper) directly or, more commonly, by being first transferred to an intermediate transfer member, which can be a soft swelling blanket, which is often heated to fuse the solid image and evaporate the liquid carrier, and then to the print substrate.

### BRIEF DESCRIPTION OF THE FIGURES

FIG. 1(a) and FIG. 1(b) show, respectively scanning electron microscope (SEM) photos of an example of the electrostatic ink described herein when printed on a substrate (a) using heat and (b) using heat and pressure.

### DETAILED DESCRIPTION

It is noted that, as used in this specification and the appended claims, the singular forms “a,” “an,” and “the” include plural referents unless the context clearly dictates otherwise.

As used herein, “liquid carrier,” “carrier liquid,” “carrier,” or “carrier vehicle” refers to the fluid in which the polymers, conductive pigment such as the metal or metal alloy pigment mentioned herein, charge directors and/or other additives can be dispersed to form a liquid electrostatic ink or electrophotographic ink. Liquid carriers can include a mixture of a variety of different agents, such as surfactants, co-solvents, viscosity modifiers, and/or other possible ingredients.

As used herein, “electrostatic ink composition” generally refers to an ink composition, which may be in liquid form, that can be used in an electrostatic printing process, sometimes termed an electrophotographic printing process. The electrostatic ink composition may comprise chargeable particles of the thermoplastic resin and the metal or metal alloy pigment, which may be as described herein, dispersed in a liquid carrier, which may be as described herein.

As used herein, “co-polymer” refers to a polymer that is polymerized from at least two monomers.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “electrostatic(ally) printing” or “electrophotographic(ally) printing” generally refers to the process that provides an image that is transferred from a photo imaging substrate or plate either directly or indirectly via an intermediate transfer member to a print substrate, e.g., a paper substrate. As such, the image is not substantially absorbed into the photo imaging substrate or plate on which it is applied. Additionally, “electrophotographic printers” or “electrostatic printers” generally refer to those printers capable of performing electrophotographic printing or electrostatic printing, as described above. “Liquid electrophotographic printing” is a specific type of electrophotographic printing where a liquid ink is employed in the electrophotographic process rather than a powder toner. An electrostatic printing process may involve subjecting the electrostatic ink composition to an electric field, e.g., an electric field having a field strength of 1000 V/cm or more, in some examples 1000 V/mm or more.

As used herein, the term “about” is used to provide flexibility to a numerical range endpoint by providing that a given value may be a little above or a little below the endpoint. The degree of flexibility of this term can be dictated by the particular variable and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. The same applies to ranges reciting a single numerical value. Furthermore, such an interpretation should apply regardless of the breadth of the range or the characteristics being described.

Unless otherwise stated, any feature described herein can be combined with any example or any other feature described herein.

In some examples, printing electrically conductive traces on substrates can be achieved using certain printing techniques, such as ink jet printing or screen printing. However, such printing techniques generally involve a post printing treatment to increase the conductivity of the printed traces. In some instances, the post-treatment to achieve high conductivity involves heating the printed substrate to high temperatures; this is known as sintering. Sintering of some metals, particularly silver can involve heating a printed substrate to a high temperature of 300-500° C. for an extended period. This allows conductive traces to be printed on certain materials, such as glass, silicon, and ceramics. However, such sintering is unsuitable for most flexible substrates such paper and plastic, since the substrate would deteriorate at the high temperature.

The present disclosure relates to electrostatic ink compositions that allow a conductive trace to be printed with no post-printing treatment. In some examples, the ink printed on the print substrate can contain metal or metal alloy pigments to allow electrical conductivity through the ink.

In some examples, the examples described herein show that the electrostatic inks described herein can be printed on a liquid electrophotographic (LEP) press to give conductive traces printed on the substrate. The metal and metal alloy pigments described herein allow sintering of the printed traces into continuous metallic traces with very high conductivity straight from the LEP press after the completion of the LEP printing process—using heat and pressure. In other words, the sintering is part of the printing process and needs no additional high temperature or high cost post treatment that can be damaging to most non-rigid and even some rigid substrates.

This direct deposition (printing) of metallic particles to give conductive traces can be useful in the printing electronics technology. This LEP direct deposition process can allow the use of large metal or metal alloy pigment particles—e.g., 0.1 μm to 10 μm. This can also allow the use of metal pigments of a wider variety including metallic alloys with low melting points—e.g., 60° C. to about 140° C.

### Electrostatic Ink(s)

In some examples, an electrostatic ink composition is described. The electrostatic ink composition can comprise: a liquid carrier; and particles dispersed in the liquid carrier, wherein the particles can comprise a thermoplastic resin, and a metal or metal alloy pigment having a melting of point of less than about 200° C.

In some examples, the metal or metal alloy pigment has a diameter of from about 0.01 μm to about 50 μm, or from about 0.1 μm to about 10 μm, or from about 1 μm to about 5 μm.

In some examples, the metal or metal alloy pigment constitutes at least 30 wt % of the solids of the electrostatic ink composition, or at least 40 wt % of the solids of the electrostatic ink composition, or at least 50 wt % of the solids of the electrostatic ink composition, or at least 60 wt % of the solids of the electrostatic ink composition, or at least 70 wt % of the solids of the electrostatic ink composition, or at least 80 wt % of the solids of the electrostatic ink composition, or at least 90 wt % of the solids of the electrostatic ink composition, or at least 95 wt % of the solids of the electrostatic ink composition, or at least 97 wt % of the solids of the electrostatic ink composition, or at least 99 wt % of the solids of the electrostatic ink composition.

In some examples, the metal or metal alloy pigment has a melting of point of less than about 200° C., or less than about 150° C., or less than about 130° C., or from about 50° C. to about 200° C., or from about 60° C. to about 150° C., or from about 70° C. to about 140° C., or from about 80° C. to about 130° C., or from about 90° C. to about 120° C.

In some examples, the melting point(s) of the metal or metal alloy pigment can be measured by using a standard test such as ASTM E793. In some examples, other method(s) of melting point measurement can be used.

In some examples, the metal or metal alloy pigment is tin, bismuth, indium, lead, gallium, cadmium, zinc, thallium, germanium, or combinations thereof.

In some examples, the metal or metal alloy pigment is bismuth, tin, indium, or combinations thereof.

In some examples, the metal or metal alloy pigment is an alloy of Bismuth/Tin alloy—58 wt %/42 wt % with a melting point of 138° C. (e.g., INDALLOY® #281 from Indium Corporation).

In some examples, the metal or metal alloy pigment is an alloy of Bismuth/Indium/Tin alloy—57 wt %/26 wt %/17 wt % with a melting point of 79° C. (e.g., INDALLOY® #174 from Indium Corporation).

In some examples, the metal or metal alloy pigment is an alloy of Indium/Bismuth/Tin alloy—51 wt %/32.5 wt %/16.5 wt % with a melting point of 60° C. (e.g., INDALLOY® #19 from Indium Corporation).

In some examples, combinations of INDALLOY® #281, INDALLOY® #174, and INDALLOY® #19 can be added to the electrostatic ink composition.

In some examples, the thermoplastic resin comprises a polymer selected from a co-polymer of (i) ethylene or propylene and (ii) an ethylenically unsaturated acid of either acrylic acid or methacrylic acid; and ionomers thereof.

In some examples, the electrostatic ink composition can further comprise a charge director.

In some examples, the liquid carrier can constitute at least 50 wt % of the electrostatic ink composition, or at least 60 wt % of the electrostatic ink composition, or at least 70 wt % of the electrostatic ink composition, or at least 80 wt % of the electrostatic ink composition, or at least 90 wt % of the electrostatic ink composition, or at least 95 wt % of the electrostatic ink composition.

### Liquid Carrier

The electrostatic ink composition can comprise a liquid carrier. Generally, the liquid carrier can act as a dispersing medium for the other components in the electrostatic ink composition. For example, the liquid carrier can comprise or be a hydrocarbon, silicone oil, vegetable oil, or combination thereof. The liquid carrier can include, but is not limited to, an insulating, non-polar, non-aqueous liquid that can be used as a medium for toner particles, e.g., the particles containing the resin and the metal or metal alloy pigment(s).

The liquid carrier can include compounds that have a resistivity in excess of about 10⁹ ohm·cm. The liquid carrier may have a dielectric constant below about 5, in some examples below about 3. The liquid carrier can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof.

Examples of the liquid carriers include, but are not limited to, aliphatic hydrocarbons, isoparaffinic compounds, paraffinic compounds, dearomatized hydrocarbon compounds, and the like. In particular, the liquid carriers can include, but are not limited to, Isopar-G™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™ Nisseki Naphthesol H™, #0 Solvent L™, #0 Solvent M™, #0 Solvent H™ Nisseki Isosol 300™, Nisseki Isosol 400™, AF-4™, AF-STM, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™)

In some examples, the liquid carrier can constitute about 20% to 99.5% by weight of the electrostatic ink composition, in some examples 50% to 99.5% by weight of the electrostatic ink composition. The liquid carrier may constitute about 40 to 90% by weight of the electrostatic ink composition. The liquid carrier may constitute about 60% to 80% by weight of the electrostatic ink composition. The liquid carrier may constitute about 90% to 99.5% by weight of the electrostatic ink composition, in some examples 95% to 99% by weight of the electrostatic ink composition.

The ink, when printed on the print substrate, may be substantially free from liquid carrier. In an electrostatic printing process and/or afterwards, the liquid carrier may be removed, e.g., by an electrophoresis processes during printing and/or evaporation, such that substantially just solids are transferred to the print substrate. Substantially free from liquid carrier may indicate that the ink printed on the print substrate contains less than 5 wt % liquid carrier, or less than 2 wt % liquid carrier, or less than 1 wt % liquid carrier, or less than 0.5 wt % liquid carrier, or less than 0.1 wt % liquid carrier. In some examples, the ink printed on the print substrate is free from liquid carrier.

### Thermoplastic Resin

In some examples, the electrostatic ink composition can comprise a resin, which may be a thermoplastic resin. In some examples, a thermoplastic polymer is sometimes referred to as a thermoplastic resin. The resin may coat the metal or metal alloy pigment, such that the particles comprise a core of metal or metal alloy pigment, and have an outer layer of resin thereon. The outer layer of resin may coat the pigment partially or completely.

In some examples, the polymer of the resin may be selected from ethylene or propylene acrylic acid co-polymers; ethylene or propylene methacrylic acid co-polymers; ethylene vinyl acetate co-polymers; co-polymers of ethylene or propylene (e.g., 80 wt % to 99.9 wt %), and alkyl (e.g., C1 to C5) ester of methacrylic or acrylic acid (e.g., 0.1 wt % to 20 wt %); co-polymers of ethylene (e.g., 80 wt % to 99.9 wt %), acrylic or methacrylic acid (e.g., 0.1 wt % to 20.0 wt %) and alkyl (e.g., C1 to C5) ester of methacrylic or acrylic acid (e.g., 0.1 wt % to 20 wt %); co-polymers of ethylene or propylene (e.g., 70 wt % to 99.9 wt %) and maleic anhydride (e.g., 0.1 wt % to 30 wt %); polyethylene; polystyrene; isotactic polypropylene (crystalline); co-polymers of ethylene ethylene ethyl acrylate; polyesters; polyvinyl toluene; polyamides; styrene/butadiene co-polymers; epoxy resins; acrylic resins (e.g., co-polymer of acrylic or methacrylic acid and at least one alkyl ester of acrylic or methacrylic acid wherein alkyl may have from 1 to about 20 carbon atoms, such as methyl methacrylate (e.g., 50% to 90%)/methacrylic acid (e.g., 0 wt % to 20 w %)/ethylhexylacrylate (e.g., 10 wt % to 50 wt %)); ethylene-acrylate terpolymers: ethylene-acrylic esters-maleic anhydride (MAH) or glycidyl methacrylate (GMA) terpolymers; ethylene-acrylic acid ionomers and combinations thereof.

In some examples, the resin may comprise a polymer having acidic side groups. Examples of the polymer having acidic side groups will now be described. The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer, in some examples a polymer having acidic side groups, that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

The acidic side groups may be in free acid form or may be in the form of an anion and associated with counterion(s), such as metal counterions, e.g., a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g., Zn, Na, Li) such as SURLYN® ionomers. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

The resin may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg

KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is NUCREL® 960 (from DuPont), and example of the second polymer is NUCREL® 699 (from DuPont), and an example of the third polymer is A-C® 5120 or A-C® 5180 (from Honeywell). The first, second and third polymers may be polymers having acidic side groups as described herein. The melt viscosity can be measured using a rheometer, e.g., a commercially available AR-2000 Rheometer from Thermal Analysis Instruments, using the geometry of: 25 mm steel plate-standard steel parallel plate, and finding the plate over plate rheometry isotherm at 120° C., 0.01 hertz shear rate.

If the resin in electrostatic ink or ink composition comprises a single type of polymer, the polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g., a commercially available AR-2000 Rheometer from Thermal Analysis Instruments, using the geometry of: 25 mm steel plate-standard steel parallel plate, and finding the plate over plate rheometry isotherm at 120° C., 0.01 hertz shear rate.

The resin may comprise two different polymers having acidic side groups that are selected from co-polymers of ethylene and an ethylenically unsaturated acid of either acrylic acid or methacrylic acid; or ionomers thereof, such as methacrylic acid and ethylene-acrylic or methacrylic acid co-polymers which are at least partially neutralized with metal ions (e.g., Zn, Na, Li) such as SURLYN® ionomers. The resin may comprise (i) a first polymer that is a co-polymer of ethylene and an ethylenically unsaturated acid of either acrylic acid and methacrylic acid, wherein the ethylenically unsaturated acid of either acrylic or methacrylic acid constitutes from 8 wt % to about 16 wt % of the co-polymer, in some examples 10 wt % to 16 wt % of the co-polymer; and (ii) a second polymer that is a co-polymer of ethylene and an ethylenically unsaturated acid of either acrylic acid and methacrylic acid, wherein the ethylenically unsaturated acid of either acrylic or methacrylic acid constitutes from 12 wt % to about 30 wt % of the co-polymer, in some examples from 14 wt % to about 20 wt % of the co-polymer, in some examples from 16 wt % to about 20 wt % of the co-polymer in some examples from 17 wt % to 19 wt % of the co-polymer.

The resin may comprise a polymer having acidic side groups, as described above (which may be free of ester side groups), and a polymer having ester side groups. The polymer having ester side groups may be a thermoplastic polymer. The polymer having ester side groups may further comprise acidic side groups. The polymer having ester side groups may be a co-polymer of a monomer having ester side groups and a monomer having acidic side groups. The polymer may be a co-polymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a co-polymer of a first monomer having ester side groups, a second monomer having acidic side groups and a third monomer which is an alkylene monomer absent of any acidic and ester side groups. The polymer having ester side groups may be a co-polymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1% to 50% by weight of the co-polymer, in some examples 5% to 40% by weight, in some examples 5% to 20% by weight of the co-polymer, in some examples 5% to 15% by weight of the co-polymer. The second monomer may constitute 1% to 50% by weight of the co-polymer, in some examples 5% to 40% by weight of the co-polymer, in some examples 5% to 20% by weight of the co-polymer, in some examples 5% to 15% by weight of the co-polymer. The first monomer can constitute 5% to 40% by weight of the co-polymer, the second monomer constitutes 5% to 40% by weight of the co-polymer, and with the third monomer constituting the remaining weight of the co-polymer. In some examples, the first monomer constitutes 5% to 15% by weight of the co-polymer, the second monomer constitutes 5% to 15% by weight of the co-polymer, with the third monomer constituting the remaining weight of the co-polymer. In some examples, the first monomer constitutes 8% to 12% by weight of the co-polymer, the second monomer constitutes 8% to 12% by weight of the co-polymer, with the third monomer constituting the remaining weight of the co-polymer. In some examples, the first monomer constitutes about 10% by weight of the co-polymer, the second monomer constitutes about 10% by weight of the co-polymer, and with the third monomer constituting the remaining weight of the co-polymer. The polymer may be selected from the BYNEL® class of monomer, including BYNEL® 2022 and BYNEL® 2002, which are available from DuPont®.

The polymer having ester side groups may constitute 1% or more by weight of the total amount of the resin polymers, e.g., thermoplastic resin polymers, in the electrostatic ink composition and/or the ink printed on the print substrate, e.g., the total amount of the polymer or polymers having acidic side groups and polymer having ester side groups. The polymer having ester side groups may constitute 5% or more by weight of the total amount of the resin polymers, e.g., thermoplastic resin polymers, in some examples 8% or more by weight of the total amount of the resin polymers, e.g., thermoplastic resin polymers, in some examples 10% or more by weight of the total amount of the resin polymers, e.g., thermoplastic resin polymers, in some examples 15% or more by weight of the total amount of the resin polymers, e.g., thermoplastic resin polymers, in some examples 20% or more by weight of the total amount of the resin polymers, e.g., thermoplastic resin polymers, in some examples 25% or more by weight of the total amount of the resin polymers, e.g., thermoplastic resin polymers, in some examples 30% or more by weight of the total amount of the resin polymers, e.g., thermoplastic resin polymers, in some examples 35% or more by weight of the total amount of the resin polymers, e.g., thermoplastic resin polymers, in the electrostatic ink composition and/or the ink printed on the print substrate. The polymer having ester side groups may constitute from 5% to 50% by weight of the total amount of the resin polymers, e.g., thermoplastic resin polymers, in the electrostatic ink composition and/or the ink printed on the print substrate, in some examples 10% to 40% by weight of the total amount of the resin polymers, e.g., thermoplastic resin polymers, in the electrostatic ink composition and/or the ink printed on the print substrate, in some examples 5% to 30% by weight of the total amount of the resin polymers, e.g., thermoplastic resin polymers, in the electrostatic ink composition and/or the ink printed on the print substrate, in some examples 5% to 15% by weight of the total amount of the resin polymers, e.g., thermoplastic resin polymers, in the electrostatic ink composition and/or the ink printed on the print substrate in some examples 15% to 30% by weight of the total amount of the resin polymers, e.g., thermoplastic resin polymers, in the electrostatic ink composition and/or the ink printed on the print substrate.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

The polymer, polymers, co-polymer or co-polymers of the resin can in some examples be selected from the NUCREL® family of toners (e.g., NUCREL® 403, NUCREL® 407, NUCREL® 609HS, NUCREL® 908HS, NUCREL® 1202HC, NUCREL® 30707, NUCREL® 1214, NUCREL® 903, NUCREL® 3990, NUCREL® 910, NUCREL® 925, NUCREL® 699, NUCREL® 599, NUCREL® 960, NUCREL® RX 76, NUCREL® 2806, BYNEL® 2002, BYNEL® 2014, and BYNEL® 2020 (sold by E. I. du PONT)), the ACLYN® family of toners (e.g., ACLYN® 201 , ACLYN® 246, ACLYN® 285, and ACLYN® 295), and the LOTADER® family of toners (e.g., LOTADER® 2210, LOTADER® 3430, and LOTADER® 8200 (sold by Arkema)).

In some examples, the metal or metal alloy pigment constitutes a certain wt %, e.g., at least 30 wt %, of the solids of the electrostatic ink composition, and the remaining wt % of the solids of the electrostatic ink composition is formed by the resin and, in some examples, any other additives that are present. The other additives may constitute 10 wt % or less of the solids of the electrostatic ink composition, in some examples 5 wt % or less of the solids of the electrostatic ink composition, in some examples 3 wt % or less of the solids of the electrostatic ink composition.

The thermoplastic resin can, in some examples is present in the electrostatic ink composition in an amount of from about 1 to about 70 wt % based on the total weight of the electrostatic ink composition, or from about 1 to about 60 wt % based on the total weight of the electrostatic ink composition, or from about 1 to about 50 wt % based on the total weight of the electrostatic ink composition, or from about 1 to about 40 wt % based on the total weight of the electrostatic ink composition, or from about 1 to about 30 wt % based on the total weight of the electrostatic ink composition, or from about 1 to about 20 wt % based on the total weight of the electrostatic ink composition, or from about 5 to about 15 wt % based on the total weight of the electrostatic ink composition.

In some examples, the resin constitutes less than 1 wt % by weight of the solids printed on the electrostatic ink composition, e.g., after heating, and/or rubbing, and/or plasma treatment.

As used herein, “resin,” “polymer,” “thermoplastic resin,” or “thermoplastic polymer” are used interchangeably.

### Charge Director and Charge Adjuvants

In some examples, the electrostatic ink composition may include a charge director. The method as described here may involve adding a charge director at any stage. The charge director may be added to impart a charge of positive or negative polarity on particles containing the resin and the metal or metal alloy pigment. In some examples, the charge director may be selected from ionic compounds, such as metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, or combinations thereof.

In some examples, the charge director is selected from, but is not limited to, oil-soluble petroleum sulfonates (e.g., neutral Calcium Petronate™, neutral Barium Petronate™, and basic Barium Petronate™) polybutylene succinimides (e.g., OLOA™ 1200 and Amoco 575), and glyceride salts (e.g., sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. In some examples, the charge director imparts a negative charge on the particles comprising the resin and metal or metal alloy pigment. In some examples, the charge director imparts a positive charge on the particles comprising the resin and metal or metal alloy pigment.

In some examples, the charge director comprises a sulfosuccinate moiety of the general formula [R_{1′}—O—C(O)CH₂CH(SO₃⁻)C(O)—O—R_{2′}], where each of R_{1′} and R_{2′} is an alkyl group. In some examples, the charge director comprises nanoparticles of a simple salt and a sulfosuccinate salt of the general formula MAₙ, wherein M is a metal, n is the valence of M, and A is an ion of the general formula [R_{1′}—O—C(O)CH₂CH(SO₃⁻)C(O)—O—R_{2′}], where each of R_{1′} and R_{2′} is an alkyl group. The sulfosuccinate salt of the general formula MAₙ is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 200 nm or less, in some examples 2 nm or more. Simple salts are salts that do not form micelles by themselves, although they may form a core for micelles with a micelle forming salt. The ions constructing the simple salts are all hydrophilic. The simple salt may comprise a cation selected from Mg, Ca, Ba, NH₄, tert-butyl ammonium, Li⁺, and Al⁺³ , or from any sub-group thereof. The simple salt may comprise an anion selected from SO₄²⁻, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. The simple salt may be selected from CaCO₃, Ba₂TiO₃, Al₂(SO₄), A1(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiCLO₄ and LiBF₄, or any sub-group thereof. The charge director may further comprise basic barium petronate (BBP).

In the formula [R_{1′}—O—C(O)CH₂CH(SO₃⁻)C(O)—O—R_{2′}], in some examples, each of R_{1′} and R_{2′}, is an aliphatic alkyl group. In some examples, each of R_{1′} and R_{2′} independently is a C₆₋₂₅ alkyl. In some examples, said aliphatic alkyl group is linear. In some examples, said aliphatic alkyl group is branched. In some examples, said aliphatic alkyl group includes a linear chain of more than 6 carbon atoms. In some examples, R_{1′} and R_{2′} are the same. In some examples, at least one of R_{1′} and R_{2′} is C₁₃H₂₇. In some examples, M is Na, K, Cs, Ca, or Ba.

The charge director may comprise (i) soya lecithin, (ii) a barium sulfonate salt, such as BBP, and (iii) an isopropyl amine sulfonate salt. BBP is a barium sulfonate salt of a 21-26 hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20%, in some examples 0.01 to 20% by weight, in some examples 0.01 to 10% by weight, in some examples 0.01 to 1% by weight of the solids of the electrostatic ink composition. In some examples, the charge director constitutes about 0.001 to 0.15% by weight of the solids of the electrostatic ink composition, in some examples 0.001 to 0.15%, in some examples 0.001 to 0.02% by weight of the solids of the electrostatic ink composition.

The electrostatic ink composition may include a charge adjuvant. A charge adjuvant may promote charging of the particles when a charge director is present. The method as described here may involve adding a charge adjuvant at any stage. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or comprises aluminum di- or tristearate. The charge adjuvant may be present in an amount of about 0.1 to 5% by weight, in some examples about 0.1 to 1% by weight, in some examples about 0.3 to 0.8% by weight of the solids of the electrostatic ink composition.

In some examples, the particles comprising the resin and the metal or metal alloy pigment further comprise a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation comprises a metal selected from Ca, Sc, Ti, V, Cr, Mn, Fe, Co, Ni, Cu, Zn, Al and Pb. In some examples, the multivalent cation is Al3+. The fatty acid anion may be selected from a saturated or unsaturated fatty acid anion. The fatty acid anion may be selected from a C8 to C26 fatty acid anion, in some examples a C14 to C22 fatty acid anion, in some examples a C16 to C20 fatty acid anion, in some examples a C17, C18 or C19 fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

In some examples, the particles comprising the resin and the metal or metal alloy pigment further comprise a salt of multivalent cation and a fatty acid anion and the composition further comprises a charge director selected from metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, and organic acid esters of polyvalent alcohols. In some examples, the particles comprising the resin and the metal or metal alloy pigment further comprise a salt of multivalent cation and a fatty acid anion and the composition further comprises a charge director selected oil-soluble petroleum sulfonates (e.g., neutral Calcium Petronate™, neutral Barium Petronate™, and basic Barium Petronate™), polybutylene succinimides (e.g., OLOA™ 1200 and Amoco 575), and glyceride salts (e.g., sodium salts of phosphated mono- and diglycerides with unsaturated and saturated acid substituents), sulfonic acid salts including, but not limited to, barium, sodium, calcium, and aluminum salts of sulfonic acid. In some examples, the particles comprising the resin and the metal or metal alloy pigment further comprise a salt of multivalent cation and a fatty acid anion and the composition further comprises a charge director selected from a sulfosuccinate moiety of the general formula [R1′-O—C(O)CH2CH(SO3-)C(O)-O-R2′], where each of R1′ and R2′ is an alkyl group, which may be as described above.

The charge adjuvant, which may, for example, be or comprise a salt of multivalent cation and a fatty acid anion, may be present in an amount of 0.1 wt % to 5 wt % of the solids of the electrostatic ink composition, in some examples in an amount of 0.1 wt % to 2 wt % of the solids of the electrostatic ink composition, in some examples in an amount of 0.1 wt % to 2 wt % of the solids of the electrostatic ink composition, in some examples in an amount of 0.3 wt % to 1.5 wt % of the solids of the electrostatic ink composition, in some examples about 0.5 wt % to 1.2 wt % of the solids of the electrostatic ink composition, in some examples about 0.8 wt % to 1 wt % of the solids of the electrostatic ink composition.

### Other Additives

In some examples, the electrostatic ink composition may comprise an additive or a plurality of additives. The additive or plurality of additives may be added at any stage of the method. The additive or plurality of additives may be selected from a wax, a surfactant, biocides, organic solvents, viscosity modifiers, materials for pH adjustment, sequestering agents, preservatives, compatibility additives, emulsifiers and the like.

The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g., from an intermediate transfer member, which may be a heated blanket.

In some examples, a wax such as a polyethylene wax (e.g., ACumist® B-6, available from Honeywell) can be added to the electrostatic inks described herein.

In some examples, a surfactant such as a fluorosurfactant (e.g., Zonyl® MP 1200 available from DuPont) can be added to the electrostatic inks described herein. In some examples, Solsperse® 11200, Solsperse® 9000, Solsperse® J560 (all available from Lubrizol Corp.), or combinations thereof were added to the electrostatic inks described herein.

The amounts of the other additives added to the electrostatic inks described herein can be from about 0 wt % to about 20 wt % based on the total weight of the electrostatic ink composition. In some examples, the other additives can be can be present in the electrostatic inks described herein in an amount of from about 1 wt % to about 10 wt % based on the total weight of the electrostatic ink composition.

### Method(s) of Using Electrostatic Ink(s)

In some examples, a method of using the electrostatic ink composition described hereinabove comprises adding the electrostatic ink composition to an electrostatic printer cartridge.

In some examples, adding the electrostatic ink composition to an electrostatic printer cartridge can comprise filling the electrostatic printer cartridge with the electrostatic ink composition.

### Method(s) of Making Electrostatic Ink(s)

In some examples, a method of making an electrostatic ink composition can comprise: mixing a liquid carrier; and particles dispersed in the liquid carrier, wherein the particles can comprise a thermoplastic resin comprising a polymer selected from a co-polymer of (i) ethylene or propylene and (ii) an ethylenically unsaturated acid of either acrylic acid or methacrylic acid; and ionomers thereof, and a metal or metal alloy pigment having a melting of point of from about 50° C. to about 150° C.

In some examples, the metal or metal alloy pigment is bismuth, tin, indium, or combinations thereof.

In some examples, the metal or metal alloy pigment have a diameter of from about 0.1 μm to about 10 μm.

In some examples, the method of making an electrostatic ink may include:

i) forming electrostatic ink particles by mixing an ethylene acid copolymer with an ethylene/(meth)acrylic acid C1-10 alkyl ester copolymer, said copolymer being present in an amount as presently disclosed, in the presence of a liquid vehicle,

ii) grinding the particles obtained in i) till the achievement of a particle size from about 0.1 micron to about 10 microns.

In some examples, grinding may include adding a second amount of liquid vehicle before or during grinding.

Process conditions to perform grinding may be adjusted depending on the specific colorant. Grinding may be performed for example for a time between about 1 and about 20 hours, for example between about 1 and about 15 hours, for example between about 10 and about 15 hours. Grinding can be performed using a single temperature profile or a temperature profile with stages. For example, temperature may not be higher than about 50° C., such as not higher than about 45° C.

If a colorant is added, it may be added either in i) or ii).

If a charge adjuvant, a charge director, a surface modifier, compatibility additives, charging additives, a wax, a biocide, a sequestering agent, a preservative, an emulsifier or transfer additives is/are added, these ingredients may be added in ii).

### Printing Process and Print Substrate

In some examples, disclosed herein is a method of electrostatic printing on a print substrate, the method comprising: forming a latent electrostatic image on a surface; contacting the surface with an electrostatic ink composition, such that at least some of the particles adhere to the surface to form a developed toner image on the surface and transferring the toner image to the print substrate.

In some examples, the electrostatic ink composition can comprise a liquid carrier; and particles dispersed in the liquid carrier, wherein the particles comprise a thermoplastic resin, and a metal or metal alloy pigment having a melting of point of less than about 200° C.

The surface on which the (latent) electrostatic image is formed or developed may be on a rotating member, e.g., in the form of a cylinder. The surface on which the (latent) electrostatic image is formed or developed may form part of a photo imaging plate (PIP). The method may involve passing the electrostatic ink composition described herein between an electrode, which may be stationary, and a rotating member, which may be a member having the surface having the (latent) electrostatic image thereon or a member in contact with the surface having the (latent) electrostatic image thereon. A voltage is applied between the electrode and the rotating member, such that particles adhere to the surface of the rotating member. The intermediate transfer member, if present, may be a rotating flexible member, which may be heated, e.g., to a temperature of from 60 to 140° C.

The print substrate may be any suitable substrate. The substrate may be any suitable substrate capable of having an image printed thereon. The substrate may comprise a material selected from an organic or inorganic material. The material may comprise a natural polymeric material, e.g., cellulose. The material may comprise a synthetic polymeric material, e.g., a polymer formed from alkylene monomers, including, but not limited to, polyethylene and polypropylene, and co-polymers such as styrene-polybutadiene. In some examples, the substrate, before printing, is or comprises plastic. In some examples, the substrate, before printing, is or comprises paper. The polypropylene may, in some examples, be biaxially orientated polypropylene.

The material may comprise a metal, which may be in sheet form. In some examples, the metal may be a metal or metal alloy pigment is tin, bismuth, indium, lead, gallium, cadmium, zinc, thallium, germanium, or combinations thereof. In some examples, the metal may be a metal or metal alloy pigment is bismuth, tin, indium, or combinations thereof.

In some examples, the metal or metal alloy pigment is an alloy of Bismuth/Tin alloy—58 wt %/42 wt % with a melting point of 138° C. (e.g., INDALLOY® #281 from Indium Corporation).

In some examples, the metal or metal alloy pigment is an alloy of Bismuth/Indium/Tin alloy—57 wt %/26 wt %/17 wt % with a melting point of 79° C. (e.g., INDALLOY® #174 from Indium Corporation).

In some examples, the metal or metal alloy pigment is an alloy of Indium/Bismuth/Tin alloy—51 wt %/32.5 wt %/16.5 wt % with a melting point of 60° C. (e.g., INDALLOY® #19 from Indium Corporation).

In some examples, combinations of INDALLOY® #281, INDALLOY® #174, and INDALLOY® #19 can be added to the electrostatic ink composition.

In an example, the substrate comprises a cellulosic paper. In an example, the cellulosic paper is coated with a polymeric material, e.g., a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The substrate is, in some examples, a cellulosic print substrate such as paper. The cellulosic print substrate is, in some examples, a coated cellulosic print.

In some examples, the method further comprises, after transferring the toner image to the print substrate, heating the print substrate and/or rubbing an object over the toner image on the print substrate, to decrease the electrical resistance of the toner image. Rubbing an object over the toner image may indicate contacting an object with the toner image and effecting relative lateral movement on the print substrate and the object, such that the object moves across the print image. The rubbing may involve pressing together the print substrate and the object. Rubbing may be carried out manually or in an automated manner. Rubbing may involve moving an object in contact with the ink on the paper at a different velocity relative to the paper. In some examples, the applied pressures can range from 240 kg/cm² to about 400 kg/cm², or from 280 kg/cm² to about 370 kg/cm², or from 290 kg/cm² to about 350 kg/cm², or from 300 kg/cm² to about 350 kg/cm². The object in contact with the ink and used for the rubbing may comprise a material selected from plastic, rubber, glass, metal, and paper, which may be soft or strong paper. In some examples, the rubbing element can be heated, which has been found to improve efficiency.

In an example of the method, the heating involves heating the print substrate to a temperature of at least 80° C., in some examples at least 90° C., in some examples at least 100° C., in some examples at least 120° C., in some examples at least 130° C., in some examples at least 150° C., in some examples at least 180° C., in some examples at least 220° C., in some examples at least 250° C., in some examples at least 280° C. The heating may be carried out for a predetermined period.

In some examples, the heating may be carried out until a sheet resistance of the ink printed on the substrate is 50 Ω/sq or less, in some examples 40 Ω/sq or less, in some examples 30 Ω/sq or less, in some examples 20 Ω/sq or less, in some examples 15 Ω/sq or less, in some examples 10 Ω/sq or less.

In an example of the method, the heating involves heating the print substrate to a temperature of from 80° C. to 250° C., for at a predetermined period of least 5 minutes, in some examples at least 10 minutes, in some examples at least 15 minutes, in some examples at least 20 minutes, in some examples at least 25 minutes, in some examples at least 30 minutes. The predetermined period may be from 5 to 60 minutes, in some examples from 15 to 45 minutes.

In an example of the method, the heating involves heating the print substrate to a temperature of from 80° C. to 250° C., in some examples of from 100° C. to 200° C., in some examples of from 100° C. to 150° C., in some examples from 110° C. to 140° C., for at least 15 minutes, and, in some examples and at most about 1 hour.

In an example of the method, the heating involves heating the print substrate to a maximum temperature of at least 250° C., in some examples for at least 10 seconds. In an example of the method, the heating involves heating the print substrate to a maximum temperature of at least 250° C., in some examples from 250° C. to 350° C., in some examples for at least 10 seconds in some examples at least 20 seconds, in some examples at least 30 second, and, in some examples and at most 5 minutes, in some examples at most 3 minutes, in some examples at most 2 minutes, in some examples 90 seconds.

In an example of the method, the method further comprises, after transferring the toner image to the print substrate, subjecting the print substrate to a plasma treatment. The substrate may be subjected to a plasma treatment for a period of at least 1 minute, in some examples at least 5 minutes, in some examples at least 10 minutes, in some examples a period of from 5 minutes to 60 minutes, in some examples 5 minutes to 30 minutes, in some examples 10 minutes to 20 minutes, in some examples 12 to 18 minutes, in some examples about 15 minutes.

In an example of the method, before contacting the surface with the electrostatic ink composition, the composition is passed between an electrode and a developer roller, the electrostatic composition then being passed on the developer roller, until it contacts the surface having the latent electrostatic image thereon.

In an example of the method, before contacting the surface with the electrostatic ink composition, the composition is passed between an electrode and a developer roller, and there is a potential difference V1 between the electrode and the developer roller, the electrostatic composition then being passed on the developer roller, until it contacts the surface having the latent electrostatic image thereon. The polarity of the potential difference may be such that the particles are disposed to be moved toward the developer roller and away from the electrode. The potential difference V1 may be from 200 to 600 V, in some examples 300 to 500 V, in some examples 350 to 450 V, in some examples about 400 V. It has been found that having relatively high potential difference assists in producing a relatively thick layer of ink on the developer roller.

In some examples, the developer roller is at a potential, relative to ground, of at least 500 V, in some examples at least 600 V, in some examples at least 700 V, in some examples from 500 V to 1000 V, in some examples from 600 V to 1000 V, in some examples from 700 V to 900 V, in some examples from 750 V to 950 V.

In some examples, the developer roller is at a potential, relative to ground of −500 V or less, in some examples −600 V or less, in some examples −700 V or less, in some examples from −500 V to −1000 V, in some examples from −600 V to −1000 V, in some examples from −700 V to −900 V, in some examples from −750 V to −950 V.

In some examples, the surface having the latent electrostatic image thereon, has a potential difference V3 between the developer roller and the area on the surface within the image (which may be termed the image area) and a potential difference V4 between the developer roller and the area on the surface outside of the image (which may be termed the non-image area). V3 may be such that the particles comprising the resin and the metal or metal alloy pigment adhere to the surface in the image area, and V4 may be such that particles are disposed to move away from the surface and toward the developer roller. In some examples, the potential difference V3 may be a value of at least 500 V, in some examples at least 600 V, in some examples at least 700 V, in some examples a value of from 500 to 1000 V, in some examples a value of from 600 to 900 V, in some examples a value of from 650 to 850 V, in some examples a value of from 700 to 800 V. In some examples, the potential difference V4 may be a value of 200 V or less, in some examples 150 V or less, in some examples 100 V or less, in some examples a value of from 80 V or less, in some examples a value of 60 V or less. It has been found that the transfer of the image seems to more effective when the potential difference between the developer roller and the image area is high relative to the potential difference between the developer roller and the non-image areas.

Further examples will become apparent in light of the examples provided below.

### EXAMPLES

### Example 1

### Metal Alloy Pigments

a. Bismuth/Tin alloy—58 wt %/42 wt % with a melting point of 138° C. (e.g., INDALLOY® #281 from Indium Corporation).

b. Bismuth/Indium/Tin alloy—57 wt %/26 wt %/17 wt % with a melting point of 79° C. (e.g., INDALLOY® #174 from Indium Corporation).

c. Indium/Bismuth/Tin alloy—51 wt %/32.5 wt %/16.5 wt % with a melting point of 60° C. (e.g., INDALLOY® #19 from Indium Corporation).

### Electrostatic Ink Composition

Resin paste containing 2.88 grams of NUCREL® 699 and 0.72 grams of A-C® 5120 and 0.4 grams of charge director, 1.2 grams of resin dispersant, and 34.8 grams of metal alloy pigment (from Indium Corporation INDALLOY® #281/#174/#19 in an average 600 nm diameter size powder) were mixed together in 160 grams of Isopar-L™ and then ground together in a ball mill (SO Union process) for about 1 hour at about 15° C. The pigment loading was 87 wt % based on the total solids weight. The obtained composition was diluted with Isopar-L™ to give 5 wt % solids dispersion. The dispersion was charged with a 0.96 grams of a negative charge director to obtain the electrostatic ink composition.

### Example 2

The electrostatic ink composition from Example 1 was used to develop a 0.5 DMA (defined mass per area—mg/(cm²)) layer on a paper (cellulosic) substrate using an LEP printing press simulation. During the LEP printing process simulation, the developed samples were subjected to either (a) heat or (b) combined heat and pressure as part of the sintering process. The sample (a) was not allowed to be roller pressed during the LEP printing process simulation whereas sample (b) was subjected to the regular heat and roller pressure during the LEP printing process simulation.

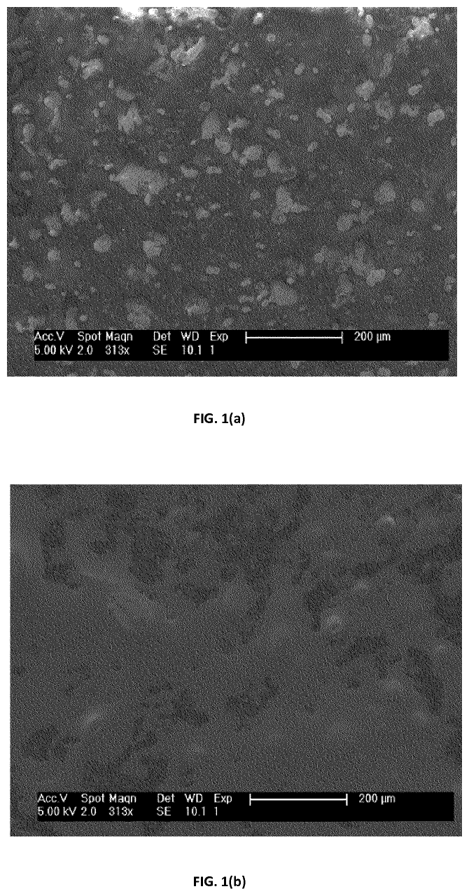

FIG. 1(a) and FIG. 1(b) show, respectively SEM photos of the example of the Example 1 ink when developed on cellulosic paper (a) using heat (no roller press) at a temperature of about 160° C. and (b) using heat and pressure (simulating regular LEP printing process) at a temperature of about 160° C. and a pressure of about 300 kg/cm².

FIG. 1(a) shows that the individual metal alloy pigment particles were still visible without forming a continuous conductive trace using heat (no pressure). In contrast, FIG. 1(b) shows that the individual metal alloy pigment particles were no longer visible and formed a continuous conductive trace using heat and pressure both.

The above examples show that the electrostatic ink described herein can be printed on an LEP press to give conductive traces printed on the substrate. The metal and metal alloy pigments described herein allow sintering of the printed traces into continuous metallic traces with very high conductivity straight from the LEP press after the completion of the LEP printing process—using heat and pressure. In other words, the sintering is part of the printing process and needs no additional high temperature or high cost post treatment that can be damaging to most non-rigid and even some rigid substrates.

This direct deposition (printing) of metallic particles to give conductive traces can be useful in the printing electronics technology. This LEP direct deposition process allows the use of large metal or metal alloy pigment particles—e.g., 0.1 μm to 10 μm. This can also allow the use of metal pigments of a wider variety including metallic alloys with low melting points—e.g., 60° C. to about 140° C.

While several examples have been described in detail, it is to be understood that the disclosed examples may be modified. Therefore, the foregoing description is to be considered non-limiting.

What is claimed is:

1. An electrostatic ink composition comprising:
a liquid carrier; and
particles dispersed in the liquid carrier,
wherein the particles comprise
a thermoplastic resin, and
a metal or metal alloy pigment having a melting of point of less than about 200° C.

2. An electrostatic ink composition according to claim 1, wherein the metal or metal alloy pigment has a diameter of from about 0.01 μm to about 50 μm.

3. An electrostatic ink composition according to claim 2, wherein the metal or metal alloy pigment has a diameter of from about 0.1 μm to about 10 μm.

4. An electrostatic ink composition according to claim 1, wherein the metal or metal alloy pigment constitutes at least 30 wt % of the solids of the electrostatic ink composition.

5. An electrostatic ink composition according to claim 1, wherein the metal or metal alloy pigment has a melting of point of less than about 150° C.

6. An electrostatic ink composition according to claim 1, wherein the metal or metal alloy pigment has a melting of point of from about 50° C. to about 150° C.

7. An electrostatic ink composition according to claim 1, wherein the metal or metal alloy pigment is tin, bismuth, indium, lead, gallium, cadmium, zinc, thallium, germanium, or combinations thereof.

8. An electrostatic ink composition according to claim 7, wherein the metal or metal alloy pigment is bismuth, tin, indium, or combinations thereof.

9. An electrostatic ink composition according to claim 1, wherein the thermoplastic resin comprises a polymer selected from a co-polymer of (i) ethylene or propylene and (ii) an ethylenically unsaturated acid of either acrylic acid or methacrylic acid; and ionomers thereof.

10. An electrostatic ink composition according to claim 1, wherein the electrostatic ink composition further comprises a charge director.

11. An electrostatic ink composition according to claim 1, wherein the liquid carrier constitutes at least 70 wt % of the electrostatic ink composition.

12. A method of using the electrostatic ink composition according to claim 1, the method comprising:
adding the electrostatic ink composition according to claim 1 to an electrostatic printer cartridge.

13. A method of making an electrostatic ink composition, the method comprising:
mixing a liquid carrier; and
particles dispersed in the liquid carrier,
wherein the particles comprise
a thermoplastic resin comprising a polymer selected from a co-polymer of (i) ethylene or propylene and (ii) an ethylenically unsaturated acid of either acrylic acid or methacrylic acid; and ionomers thereof, and
a metal or metal alloy pigment having a melting of point of from about 50° C. to about 150° C.

14. The method of making the electrostatic ink composition according to claim 13, wherein the metal or metal alloy pigment is bismuth, tin, indium, or combinations thereof.

15. The method of making the electrostatic ink composition according to claim 13, wherein the metal or metal alloy pigment have a diameter of from about 0.1 μm to about 10 μm.
